(19) United States
(12) Patent Application Publication
(10) Pub. No.: US 2010/0237638 A1
(43) Pub. Date: Sep. 23, 2010

(54) ENERGY-DISSIPATING ELEMENT AND SHOCK ABSORBER COMPRISING AN ENERGY-DISSIPATING ELEMENT

(76) Inventors: Uwe Beika, Lubbenau (DE); Steffen Drobek, Magdeburg (DE)

Correspondence Address: CESARI AND MCKENNA, LLP, 88 BLACK FALCON AVENUE, BOSTON, MA, 02210, US

(21) Appl. No.: 12/712,490

(22) Filed: Feb. 25, 2010

(30) Foreign Application Priority Data
Mar. 20, 2009 (EP) 09155732.2

(51) Int. Cl. B60R 19/24

(52) U.S. Cl. 293/129

(57) ABSTRACT

An energy-dissipating element has the form of a hollow body extending in the longitudinal direction, wherein the element comprises a wall forming the peripheral surface of the hollow body. The element is designed to respond upon the exceeding of a critical impact force applied to a front of the element and to convert at least a portion of the impact energy ensuing from the transfer of the impact force through the element into the energy and heat of deformation by plastic deformation. The energy-dissipating element is composed of at least one deformation element formed from a hollow profile and extending along the longitudinal axis of the hollow body which forms the wall of the energy-dissipating element.

### BACKGROUND OF THE INVENTION

1. Field of the Invention

The present invention relates to an energy-dissipating element in the form of a longitu-dinally-extending hollow body, wherein the energy-dissipating element comprises a wall forming the peripheral surface of the hollow body, and wherein the energy-dissipating element is designed to respond upon the exceeding of a critical impact force applied to a front end of said energy-dissipating element and to absorb at least a portion of the impact energy ensuing from the transfer of the impact force through the energy-dissipating element by plastic deformation; i.e. converting it to the energy and heat of deformation. The invention further relates to a shock absorber, in particular for use as a side buffer on the front end of a rail-bound vehicle such as e.g. a railroad vehicle, or for use in a buffer stop, wherein the shock absorber comprises an energy-dissipating is element of the type described above.

Energy-dissipating elements of the above type are in principle generally known in the prior art and are used for example in rail vehicle technology, in particular as components of shock absorbers. Usually, a shock absorber of this type for rail vehicles consists of a combination of a drawgear (for example in the form of a spring device) and an irreversible energy-dissipating element, whereby the energy-dissipating element serves to protect the vehicle, in particular also at greater speeds of impact. It is thereby typically provided for the drawgear to accommodate tractive and impact forces up to a defined magnitude and initially conduct any forces exceeding that to an energy-dissipating element and then further conduct the energy exceeding the dimensioned energy level to the vehicle underframe.

Thus, while tractive and impact forces which occur during normal vehicle operation, for example between the individual car bodies of a multi-member vehicle, are absorbed by the normally regeneratively-configured drawgear, when the operating load of the drawgear is exceeded, for instance upon the vehicle colliding with an obstacle, the drawgear as well as any articulated or coupled connections as may be provided between the individual car bodies, the interface between the individual car bodies respectively, may conceivably be destroyed or damaged. At higher collision energies, the drawgear alone will not suffice to absorb the whole of the resultant energy. This gives rise to the risk of involving the vehicle underframe, respectively the entire railcar body, in the further absorbing of energy. Doing so subjects same to extreme loads and may possibly damage or even destroy same. In such cases, the railcar bodies run the risk of derailment.

A destructive energy-dissipating element is often used as an additional or solitary energy-dissipating device with the objective of protecting the vehicle underframe against damage from severe impact, the same being designed for example so as to respond when the drawgear's operational absorption is exhausted and to absorb, and thus dissipate, at least a portion of the energy transferred by the force flow through said is energy-dissipating element. A conceivable example of energy-dissipating elements are deformation bodies which, upon a critical compressive force being exceeded, convert the impact energy into the energy and heat of deformation by a (deliberate) destructive plastic deformation.

An energy-dissipating element which utilizes a deformation tube to convert the impact energy exhibits an essentially rectangular characteristic curve, whereby maximum energy absorption is ensured following the activation of said energy-dissipating element.

2. The Prior Art

Using a conventional energy-dissipating element in a shock absorber is known for example from DE 102 52 175 A1. In this prior art, the shock absorber is configured as a plunger buffer for mobile or stationary support structures. It makes use of a telescoping structure comprising a buffer housing in the form of a buffer sleeve, a force-transferring member in the form of a plunger accommodated at least partly therein, as well as a damping element in the form of e.g. a spring or an elastomer body. With this type of structure, the buffer housing serves as a longitudinal guide and as support against lateral forces, while the damping element (spring or elastomer body) accommodated in the buffer housing serves to transmit force in the longitudinal direction.

The DE 102 52 175 A1 printed publication considers the problem of impact forces exceeding the characteristic operating load of the plunger buffer not being further conducted unattenuated to the support structure upon the maximum buffer stroke being reached, i.e. after the damping characteristic of the damping element has been exhausted. To this end, the guiding members of this known prior art plunger buffer are designed such that after the maximum buffer stroke has been exhausted, a guiding member of the plunger strikes a defined arrester and thereby ruptures the appropriately provided break-off connections between the guiding member of the plunger and the plunger. The provision of such break-off connections allows increasing the deformation length of the buffer since a relative movement of the plunger toward the buffer housing is enabled once the break-off connections fail. The increased deformation length thereby achievable allows the buffer housing to plastically deform upon overload.

Specifically, an end section of the plunger is accommodated telescopically in the buffer housing in the solution known from the DE 102 52 175 A1 printed publication. When the break-off connections respond, the plunger moves toward the buffer housing, in consequence of which the buffer housing is plastically deformed such that the impact energy is destructively converted into the energy and heat of deformation.

In this known prior art solution, the buffer housing is thus accorded the function of an energy-dissipating element upon overload, one which is designed to respond upon the exceeding of a critical impact force introduced to a front end of the energy-dissipating element and absorb at least a portion of the impact energy resulting from transferring impact force through the energy-dissipating element by plastic deformation; i.e. convert it to the energy and heat of deformation. Hence, shock absorbance is provided in the deformation of the buffer housing occurring upon overload. Accordingly, the plunger buffer known from this prior art is designed to protect the support structure to a certain extent from damage upon strong collisions.

The disadvantage in this is that, based on its design, this prior art solution can only make use of about half of the buffer's overall length when absorbing shock. After the buffer housing deforms, it is in particular not possible in the known solution to have a further shortening in the longitudinal direction of the buffer, and thus nor a plastic deformation of the buffer housing.

Having said that, it is further known from the prior art to use an energy-dissipating element, for example in the form of a deformation tube, as a shock absorber.

The shock absorber responds upon a critical response force being exceeded, whereby at least a portion of the energy resulting from the transfer of force is converted into the energy of deformation and heat and thus “absorbed” by the plastic deformation of the deformation tube. It is thereby known to press the deformation tube through a conical hole provided for example in a nozzle plate, effecting its cross-sectional reduction. Or the deformation tube undergoes cross-sectional enlargement while being squeezed over a conical ring. In this embodiment of a shock absorber, additional space needs to be provided to receive the plastically-deformed deformation tube.

### SUMMARY OF THE INVENTION

Based on the aforesaid disadvantages, the task on which the present invention is based is that of further developing an energy-dissipating element of the type cited at the outset such that the space required for receiving the energy-dissipating element when dissipating energy can be used as optimally as possible. In particular, an energy-dissipating element of the type cited at the outset is to be further developed such that the energy-dissipating element when activated can plastically deform over the longest possible—in relation to its overall length—deformation path in the longitudinal direction of said energy-dissipating element so as to enable sufficiently high energy dissipation from a defined response of the energy-dissipating element as well as a predictable sequence of events during the absorbing of the energy.

This task is solved in accordance with the invention by an energy-dissipating element of the type cited at the outset being provided with at least one deformation element formed from a profile and extending along the longitudinal axis of the hollow body which forms the wall of the energy-dissipating element configured as a longitudinal-extending hollow body.

For the energy-dissipating element configured in the form of a hollow body as a defor-mation element, it is hereby conceivable to use, for example, a toroidal deformation element configured from a profile, for instance a hollow profile, whereby the rotational axis of the toroidal deformation element corresponds to the longitudinal axis of the hollow body. In one preferred realization, at least two toroidal deformation elements are provided, each extending along the longitudinal axis of the hollow body, whereby the rotational axis of each of the at least two toroidal deformation elements corresponds to the longitudinal axis of the hollow body. Of course it is however also possible to use only one single toroidal deformation element to form the energy-dissipating element.

Likewise conceivable to use hereto as an alternative for the energy-dissipating element configured in the form of a hollow body as a deformation element is a helical or spiral-shaped deformation element formed from a profile, whereby the longitudinal axis of the helical or spiral-shaped deformation element corresponds to the longitudinal axis of the hollow body. The helical or spiral-shaped deformation element is should thereby preferably have at least two stacked coils with or without gap.

The advantages attainable with the inventive solution are obvious: Regardless of whether a toroidal deformation element formed from a profile or a helical or spiral-shaped deformation element formed from a profile is used, an essentially tubular or conical energy-dissipating element is formed. The peripheral surface of the energy-dissipating element is formed by the outer surfaces of the coils themselves. Because the at least one toroidal or helical/spiral-shaped deformation element is formed from a profile, a hollow profile in particular, the individual toroidal deformation elements, the individual coils of the helical or spiral-shaped deformation element respectively, plastically deform when the energy-dissipating element is activated. This has the consequence that when the energy-dissipating element responds, the block length of the energy-dissipating element at its maximum deformation is particularly small relative the length of the energy-dissipating element in its non-deformed state compared to the solutions known from the prior art and described above.

The inventive solution allows the dissipating of a high amount of energy with a low longitudinal shortening of the energy-dissipating element. Thus, the space needed to install the energy-dissipating element and for its deployment in the event of a crash can be reduced.

Because of the special structure to the energy-dissipating element configured as a hollow body comprising the at least one deformation element formed from a profile and extending along the longitudinal axis of the hollow body, the energy-dissipating element has a self-stabilizing character when absorbing energy. This particularly holds true in each deformation state of the energy-dissipating element. A predictable sequence of events to the absorption of energy is thus possible. Furthermore, the energy-dissipating element can be structurally connected to further components both axially as well as radially since the energy-dissipating element exhibits sufficient structural stability longitudinally and laterally not only in its non-deformed state, but also in its deformed state.

A further advantage of the inventive solution is noted in that the response behavior of the energy-dissipating element is insensitive to any imperfections there may is be in the material of said energy-dissipating element.

These advantages can then also be achieved when a helical or spiral-shaped deformation element formed from a profile is used for the deformation element extending along the longitudinal axis of the hollow body, whereby the longitudinal axis of the helical or spiral-shaped deformation element corresponds to the longitudinal axis of the hollow body. The advantage of the helical or spiral-shaped deformation element can be seen to be that during deformation, there is a continuous deformation of the helical or spiral profile cross-section in the direction of the helix or spiral longitudinal axis at a virtually constant level of deformation force.

The profile from which the at least one deformation element (toroidal or helical deformation element) extending along the longitudinal axis of the hollow body is formed can exhibit any discretional cross-sectional geometry such as, in particular, a circular, elliptical, hexagonal or rectangular cross-sectional geometry. Having said that, it is of course also conceivable for the profile to be configured as an open cross-section profile such as for example a profile having an “L”, “U”, double-T or Z-shaped cross-section.

The longitudinally-extending hollow body of the energy-dissipating element which is formed by the at least one deformation element formed from the hollow profile and extending along the longitudinal axis of the hollow body can exhibit a cross-section which is unchanged over the longitudinal direction of the energy-dissipating element. On the other hand, it is of course also possible for the cross-section of the hollow body to vary over the longitudinal direction of the energy-dissipating element. In particular, it is hereby conceivable for the hollow body to exhibit a tapering form. This type of conical design has the advantage of higher stability for the energy-dissipating element relative lateral forces and moments and relative eccentric longitudinal forces.

One preferred further development of the inventive energy-dissipating element in which the wall of the hollow body is formed from a plurality of toroidal deformation elements in an adjoining arrangement, and which can be joined together by a material fit, provides for at least one auxiliary toroidal deformation element formed from a hollow profile, its rotational axis corresponding to the rotational axes of the plurality of toroidal deforma-tion elements. The auxiliary toroidal deformation element can hereby be arranged in an annular groove formed between two adjoining toroidal deformation elements and connected to the adjoining toroidal deformation elements by material fit or adhesive. On the other hand, however, it is also conceivable to arrange the auxiliary toroidal deformation element externally to an annular groove formed between two adjoining toroidal deformation elements.

Having said that, conceivable with a energy-dissipating element in which the deformation element configured as a helical or spiral element is formed from a hollow profile extending along the longitudinal axis of the hollow body is for an auxiliary helical or spiral-shaped deformation element to be provided additionally to said helical or spiral deformation element, whereby the longitudinal axis of this auxiliary helical or spiral-shaped deforma-tion element corresponds to the longitudinal axis of the deformation element. In the process, the coils of the auxiliary helical or spiral-shaped deformation element can be arranged in a groove configured between the coils of said helical or spiral deformation element. However it is of course also conceivable for the auxiliary helical or spiral-shaped deformation element to exhibit a different coiling direction and/or different pitch compared to the helical or spiral deformation element such that the auxiliary helical or spiral-shaped deformation element is not arranged in a groove configured between the coils of the helical or spiral deformation element. The auxiliary helical or spiral-shaped deformation element is preferably to be connected to the helical or spiral deformation element at least at one spot by material fit or adhesive. It would of course also be conceivable for the auxiliary helical or spiral-shaped deformation element to be held to the helical or spiral deformation element by tension.

The following will make reference to the accompanying figures in describing embodiments of the inventive energy-dissipating element in greater detail.

### BRIEF DESCRIPTION OF THE DRAWINGS

In the drawings:

FIG. 1 is a side view of a first embodiment of the inventive energy-dissipating element;

FIG. 2 is a longitudinally-sectioned representation of the energy-dissipating is element depicted in FIG. 1 in accordance with the first embodiment of the invention;

FIG. 3 is a side view of a second embodiment of the inventive energy-dissipating element;

FIG. 4 is a longitudinally-sectioned representation of the energy-dissipating element depicted in FIG. 3 in accordance with the second embodiment of the invention;

FIG. 5 is a side view of a third embodiment of the inventive energy-dissipating element;

FIG. 6 is a longitudinally-sectioned representation of the energy-dissipating element depicted in FIG. 5 in accordance with the third embodiment of the invention;

FIG. 7 is a side view of a fourth embodiment of the inventive energy-dissipating element;

FIG. 8 is a longitudinally-sectioned representation of the energy-dissipating element depicted in FIG. 7 in accordance with the fourth embodiment of the invention;

FIG. 9 is conceivable cross-sectional shapes for the hollow profile from which the at least one deformation element is formed;

FIG. 10a is a perspective view of an embodiment of the inventive energy-dissipating element in the non-deformed state, and

FIG. 10b is a longitudinally-sectioned representation of the energy-dissipating element depicted in FIG. 10a at maximum deformation.

### DESCRIPTION OF PREFERRED EMBODIMENTS

FIG. 1 depicts a side view of a first embodiment of the inventive energy-dissipating element 1. The energy-dissipating element 1 is arranged between a force-transferring element 4 and a base plate 5 such that compressive forces introduced into the force-transferring element 4 will be transmitted over wall 2 of the energy-dissipating element 1 to the base plate 5. As depicted, the energy-dissipating element 1 is configured in the form of a hollow body extending in the longitudinal direction L. The peripheral surface of the hollow body is formed by the wall 2 of energy-dissipating element 1.

With the first embodiment of the inventive energy-dissipating element 1 is depicted in FIG. 1, the wall 2 of said energy-dissipating element 1 is formed by a plurality of toroidal deforma-tion elements 3.1 to 3.n. These toroidal deformation elements 3.1 to 3.n are arranged such that the rotational axis L′ of each toroidal deformation element 3.1 to 3.n corresponds to the longitudinal axis L of the hollow body.

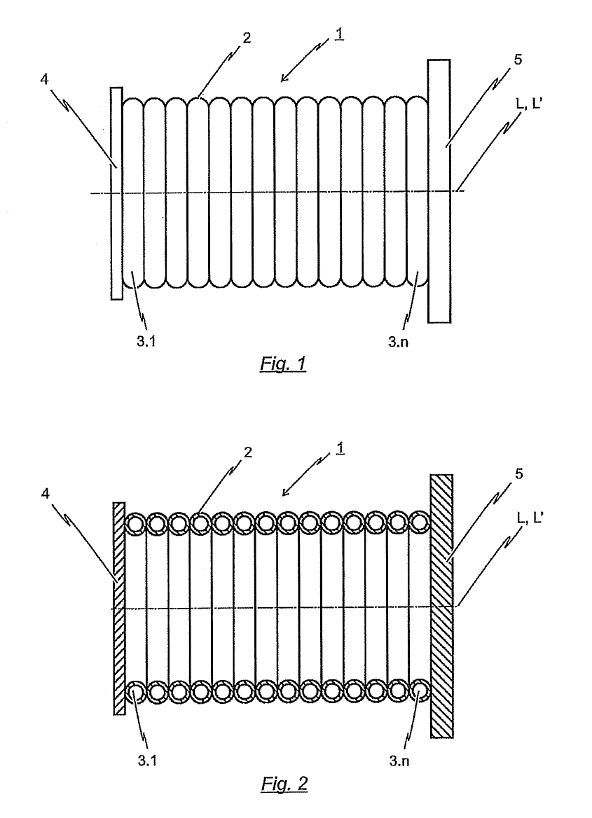

It can be directly seen from the FIG. 2 depiction, which shows a longitudinally-sectioned representation of the energy-dissipating element 1 shown in FIG. 1, that the toroidal deformation elements 3.1 to 3.n are stacked flush in the longitudinal direction L of the energy-dissipating element 1. The adjoining toroidal deformation elements 3.1 to 3.n are interconnected. It is hereby conceivable for the individual toroidal deformation elements 3.1 to 3.n to be externally and/or internally connected together by means of radial and/or longitudinal welded seams or spot weldings. Although it is of course also conceivable to tension or adhesively bond the respective contact surfaces of the respectively adjoining toroidal deformation elements 3.1 to 3.n.

It can further be seen from the FIG. 2 depiction that each toroidal deformation element 3.1 to 3.n is formed from a profile. In so doing, closed hollow profiles having a circular cross-sectional shape are specifically used. It is of course also conceivable to make use of profiles having other, for example hexagonal, elliptical or rectangular, cross-sectional geometries to form the toroidal deformation elements 3.1 to 3.n.

FIG. 9 shows examples of possible profile cross-sectional geometries. Generally speaking, although metallic material is suited as the profile material, plastics are also conceivable, for example thermoplastics or fiber-reinforced plastics.

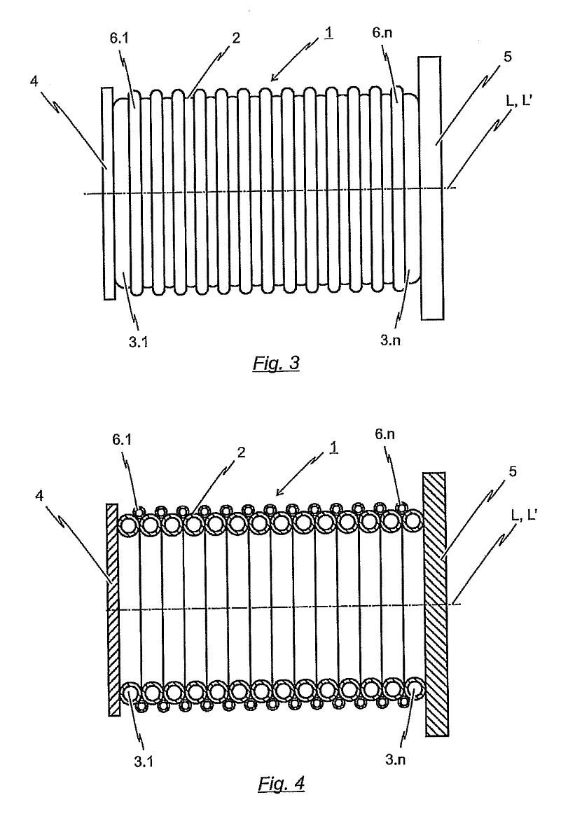

FIG. 3 shows a side view of a second embodiment of the inventive energy-dissipating element 1. FIG. 4 is a longitudinally-sectioned representation of the energy-dissipating element 1 depicted in FIG. 3.

The second embodiment of the inventive energy-dissipating element 1 differs from the embodiment previously described with reference to the FIGS. 1 and 2 representations in that additionally to toroidal deformation elements 3.1 to 3.n, a plurality of auxiliary toroidal deformation elements 6.1 to 6.n are provided. These auxiliary toroidal deformation elements 6.1 to 6.n are likewise formed from a profile. The profile of the auxiliary deformation elements 6.1 to 6.n can have a cross-section which differs from the cross-section of the hollow profile used for the toroidal deformation elements 3.1 to 3.n. In the embodiment of the energy-dissipating element 1 depicted in FIGS. 3 and 4, the auxiliary toroidal deformation elements 6.1 to 6.n have a smaller cross-section than that of deformation elements 3.1 to 3.n. The cross-sections of auxiliary deformation elements 6.1 to 6.n can, however, also be the same size or larger than the cross-sections of deformation elements 3.1 to 3.n.

As can be particularly noted from the FIG. 4 representation, each auxiliary toroidal deformation element 6.1 to 6.n is arranged in an annular groove formed between two adjoining toroidal deformation elements. As shown for example in FIG. 9, different cross-sectional geometries are applicable for the cross-sectional shape of the profile used to form the auxiliary toroidal deformation elements 6.1 to 6.n.

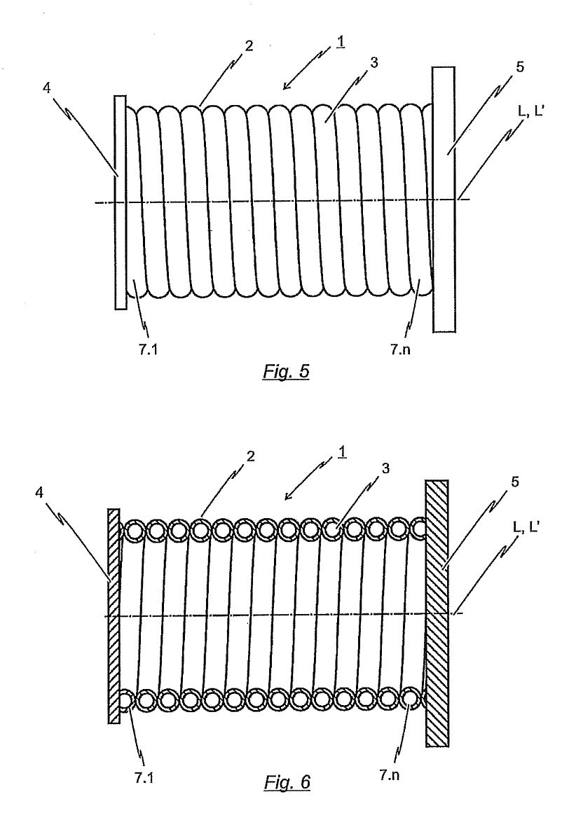

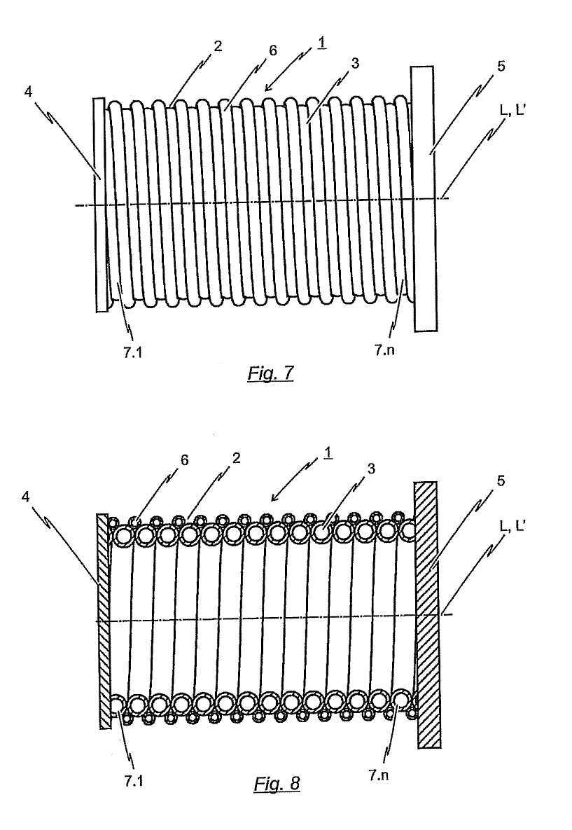

FIGS. 5 and 6 depict a third embodiment of the inventive energy-dissipating element 1. In detail, FIG. 5 shows a side view of an energy-dissipating element 1 according to the third embodiment while FIG. 6 shows a longitudinally-sectioned representation of the energy-dissipating element 1 depicted in FIG. 5.

In contrast to the first embodiment of the inventive energy-dissipating element 1, the third embodiment makes use of only one deformation element formed from a profile and extending along the longitudinal axis of the hollow body. This single deformation element is configured here as a helical deformation element 3, its longitudinal axis L′ correspon-ding to the longitudinal axis L of the hollow body. In detail, the helical deformation element 3 exhibits a plurality of stacked coils 7.1 to 7.n with or without gap, whereby the individual coils of the respectively adjoining profile coils 7.1 to 7.n of helical deformation element 3 can be connected together by e.g. material fit.

Alternatively or additionally hereto, it is conceivable to provide e.g. longitudinal welded seams on the outer side of wall 2 of energy-dissipating element 1 and/or on the inner wall side of said energy-dissipating element 1.

The profile from which the helical deformation element 3 is formed in accordance with the FIGS. 5 and 6 representations can have—as depicted—a circular cross-sectional geometry. As depicted exemplarily in FIG. 9, however, other cross-sectional shapes are also conceivable such as e.g. elliptical, hexagonal or rectangular cross-sectional shapes. The profile from which the helical deformation element 3 is formed is preferably of a metallic material, although other materials like plastics would also be suitable.

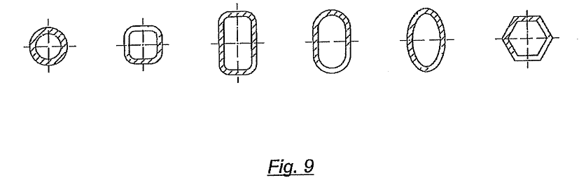

FIGS. 7 and 8 depict a fourth embodiment of the inventive energy-dissipating element 1. This fourth embodiment essentially corresponds to the above third embodiment depicted with reference to the FIGS. 5 and 6 representations, whereby in addition to helical deformation element 3, however, an additional auxiliary helical deformation element 6 formed from a profile is provided, its longitudinal axis corresponding to the longitudinal axis L′ of the helical deformation element. As can be seen particularly from the FIG. 8 representation, it is possible for the coils of the auxiliary helical deformation element 6 to be arranged in a helical groove formed between the coils 7.1 to 7.n of helical deformation element 3. In so doing, the auxiliary helical deformation element 6 is to be connected or adhesively bonded to the helical deformation element 3 at least at one spot. It would of course also be conceivable for the auxiliary helical deformation element 6 to be held to helical deformation element 3 by tension.

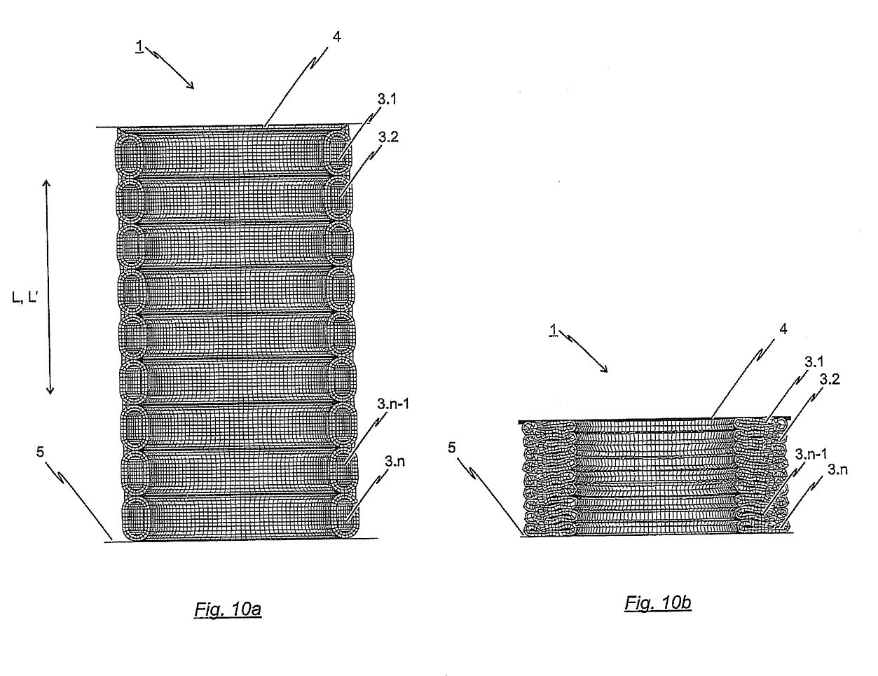

The following will reference the FIGS. 10a and 10b representations in providing a more detailed description of how the inventive energy-dissipating element 1 functions. Although FIGS. 10a and 10b show an energy-dissipating element 1 exhibiting a deformation element in the form of a hollow body in which the hollow body is formed by a plurality of toroidal deformation elements 3.1 to 3.n, the following remarks can also be figuratively applied to energy-dissipating elements formed using helical or spiral deformation elements.

FIG. 10a shows an energy-dissipating element 1, as was described above for example referencing the FIGS. 1 and 2 representations, in the non-deformed state. FIG. 10b shows a longitudinally-sectioned representation of the energy-dissipating element 1 at maximum deformation.

As the figures illustrate, it can be seen that an energy-dissipating element 1 configured in accordance with the teachings of the present invention converts impact energy into the energy and heat of deformation through the plastic deformation of the hollow profile cross-sections along the torus axis L after a predefinable critical response force has been exceeded. Because the toroidal structure is not destroyed in the absorbing of energy, the energy-dissipating element 1 exhibits a longitudinal and lateral structural stability even in the deformed state. This allows the energy-dissipating element 1 to be structurally connected to further components in both the axial as well as the radial direction.

As can especially be seen in FIG. 10b, upon the activation of the energy-dissipating element 1, the toroidal deformation elements 3.1 to 3.n formed from the hollow profile compress the deformation element in the longitudinal direction of said energy-dissipating element 1. This also holds true figuratively for an energy-dissipating element 1 not making use of one or multiple toroidal deformation elements but instead utilizing a helical or spiral deformation element. In the case of a helical or spiral structure, when the energy-dissipating element is activated, a continuous deformation of the hollow profile cross-section occurs along the helical axis, along the longitudinal axis of said energy-dissipating element respectively, whereby this occurs at a virtually steady level of defor-mation force in the direction of the helical or spiral longitudinal axis. In the case of a toroidal structure to the energy-dissipating element, a sequential deformation of the hollow profile cross-sections of the individual toroidal deformation elements 3.1 to 3.n occurs upon activation of the energy-dissipating element 1 so that the deformation forces only oscillate slightly.

Regardless of whether a helical/spiral structure or a toroidal structure is selected for deformation element 3 or 3.1, the deformation element has a self-stabilizing character in each respective state of deformation. The profile design thereby enables a low ratio between the block length of the energy-dissipating element at maximum deformation and the initial length in the non-deformed state.

The invention is not limited to the embodiments of the energy-dissipating element 1 depicted in the figures. It is in particular conceivable for the outer and/or inner is surface of the energy-dissipating element 1 configured as a hollow body to be reinforced or welded, whereby greater static and dynamic stability both in the longitudinal direction as well as in the lateral direction of the energy-dissipating element 1 can then be achieved. The deformation force level can thereby be increased, whereby an advantageous increase in the energy absorbed occurs at the same profile cross-sections and the same material thickness since the exhaustible maximum deformation path is only slightly reduced despite the welded seams.

It is also conceivable for the energy-dissipating element 1 to be configured in the form of a hollow body having a cross-section which changes along the longitudinal axis. Although needing to remain ensured in this case is that the profile geometry has to be deformable in the longitudinal direction of the energy-dissipating element. Examples of cross-sectional changes might be two or more alternatingly arranged cross-sections or expanded or tapered cross-sections extending in the longitudinal direction of the energy-dissipating element so as to form e.g. a conical or truncated pyramid for the basic form of the energy-dissipating element. It is further conceivable for the coil diameter of the toroidal deformation element, the spiral or helical deformation element respectively, to vary over the length of the dissipating element.

FIG. 9 depicts examples of conceivable profile cross-sections. Accordingly applicable are closed hollow profiles having e.g. annular, rectangular, hexagonal or oval cross-sections. Although not explicitly shown, an open cross-sectional form is also possible for the profile, for example an “L”, “U”, double-T or Z-shaped cross-sectional form.

As already indicated above, the inventive energy-dissipating element is applicable as a shock absorber having a base plate and a force-transferring element, whereby the energy-dissipating element is arranged between the base plate and the force-transferring element. In one preferred embodiment of such a shock absorber, the energy-dissipating element is mounted between the base plate and the force-transferring element without play.

The energy-dissipating element can be structurally connected to further is components both in the axial as well as in the radial direction since the energy-dissipating element exhibits a structural stability in the longitudinal and lateral direction even in the deformed state, and which can be even higher than in the non-deformed initial state. Advantageous is a connection for example to directly-adjoining inner or outer bodies having the same tubular cross-section corresponding to the energy-dissipating element, whereby added sliding friction support accompanying deformation generates a uniform path for the deformation force.

A shock absorber making use of the inventive energy-dissipating element is particularly applicable as a side buffer on the front end of a rail-bound vehicle, in particular a railroad vehicle, or in a buffer stop. However, other applications are of course also conceivable, for example in other vehicles or stationary applications.

1. An energy-dissipating element for vehicles and stationary constructions in the form of a hollow body extending in a longitudinal direction, wherein
the energy-dissipating element comprises a wall forming the peripheral surface of the hollow body;
the energy-dissipating element is designed to respond upon the exceeding of a critical impact force applied to a front end of said energy-dissipating element and thereby convert at least a portion of the impact energy ensuing from the transfer of the impact force through the energy-dissipating element into the energy and heat of deformation by plastic deformation;
at least one deformation element formed from a profile and extending along the longitudinal axis of the hollow body is provided which forms the wall of said energy-dissipating element;
the deformation element extending along the longitudinal axis of the hollow body is configured as a helical or spiral-shaped deformation element, its longitudinal axis is corresponding to the longitudinal axis of the hollow body;
the helical or spiral-shaped deformation element exhibits two stacked coils, preferably without gap, and the contact surfaces of the adjoining coils are preferably joined together by pointwise material fit.

2. The energy-dissipating element according to claim 1,
wherein the at least one deformation element is formed from a closed cross-section hollow profile.

3. The energy-dissipating element according to claim 1 or 2,
wherein the deformation element extending along the longitudinal axis of the hollow body is configured to be of toroidal shape, wherein the rotational axis of the toroidal deformation element corresponds to the longitudinal axis of the hollow body.

4. The energy-dissipating element according to claim 1 or 2,
wherein additionally to the helical or spiral-shaped deformation element, an auxiliary helical or spiral-shaped deformation element formed from a hollow profile is provided, the longitudinal axis thereof corresponding to the longitudinal axis of the helical or spiral-shaped deformation element, wherein the coils of the auxiliary deformation element are preferably arranged in a groove formed between the coils of the deformation element, and wherein the auxiliary deformation element is preferably connected to the deformation element at least at one spot by material fit.

5. The energy-dissipating element according to claim 4,
wherein the auxiliary deformation element exhibits a different coil direction and/or pitch compared to deformation element.

6. The energy-dissipating element according to claim 1 or 2,
wherein at least two deformation elements each formed from a hollow profile and extending along the longitudinal axis of the hollow body and adjoining at contact surfaces are provided, and wherein the at least two deformation elements are joined together in a material fit connec-tion extending in the longitudinal direction of the energy-dissipating element.

7. The energy-dissipating element according to claim 1 or 2,
wherein the profile from which the at least one deformation element extending along the longitudinal axis of the hollow body is formed, exhibits a circular, elliptical, hexagonal or rectangular cross-section.

8. The energy-dissipating element according to claim 1,
wherein the profile from which the at least one deformation element extending along the longitudinal axis of the hollow body is formed, is configured as an open cross-section profile, in particular as a profile having an “L”, “U”, double-T or Z-shaped cross-section.

9. The energy-dissipating element according to claim 1 or 2,
wherein the hollow body exhibits a circular, elliptical, hexagonal or rectangular cross-section.

10. The energy-dissipating element according to claim 1 or 2,
wherein the cross-section of the hollow body is unchanged over the longitudinal direction of the energy-dissipating device.

11. The energy-dissipating element according to claim 1,
wherein the cross-section of the hollow body varies over the longitudinal direction of the energy-dissipating device.

12. A shock absorber, in particular for use as a side buffer on the front end of a vehicle, in particular a rail-bound vehicle, or for use in a stationary construction, in particular in a buffer stop, wherein the shock absorber comprises:
a base plate;
a force-transferring element, and
an energy-dissipating element mounted between the base plate and the force-transferring element without play according to claim 1 or 2.
